(19) United States
(12) Patent Application Publication
(10) Pub. No.: US 2025/0088020 A1
(43) Pub. Date: Mar. 13, 2025

(54) CHARGE MODE SWITCHING

(71) Applicant: MILWAUKEE ELECTRIC TOOL CORPORATION, Brookfield, WI (US)

(72) Inventor: Logan Matthew Manderle, Milwaukee, WI (US)

(21) Appl. No.: 18/822,774

(22) Filed: Sep. 3, 2024

Related U.S. Application Data
(60) Provisional application No. 63/582,298, filed on Sep. 13, 2023.

(51) Int. Cl. H02J 7/00; H01M 10/44

(52) U.S. Cl. CPC H02J 7/007; H01M 10/441; H02J 7/00032; H02J 7/0013

(57) ABSTRACT

Systems and method for controlling a charge mode for a battery charger. One system includes a first microcontroller unit configured to charge a first battery pack via a first power source, a second microcontroller unit configured to charge a second battery pack via a second power source, the second power source electrically isolated from the first power source, an opto-isolation circuit, and an input mechanism. The first microcontroller unit configured to receive a signal output by the input mechanism representing a selected charge mode, control charging of the first battery pack via the first power source based on the selected charge mode, and communicate the selected charge mode to the second microcontroller unit via the opto-isolation circuit.

### RELATED APPLICATIONS

This application claims priority to U.S. Provisional Application No. 63/582,298, filed Sep. 13, 2023, the entire contents of which is incorporated by reference herein.

### FIELD

Embodiments described herein generally relate to battery chargers and, more particularly, to controlling a charge mode for one or more power tool battery packs charged via a battery charger.

### SUMMARY

Embodiments described herein provide systems and methods for charging power tool battery packs, such as, for example, controlling a charge mode of a plurality of battery packs connected to a battery charger. One embodiment provides a power tool battery pack charger including a first microcontroller unit, a second microcontroller unit, and a plurality of battery pack interfaces for charging a plurality of battery packs. The first microcontroller unit is configured to receive a signal representing a selected charge mode, wherein the selected charge mode includes a first charging mode or a second charge mode. The first microcontroller unit is further configured to control a charge operation of at least a first one of the plurality the battery packs based on the selected charge mode, and communicate, via an opto-isolation circuit, the selected charge mode to the second microcontroller unit. At least one of the first microcontroller unit and the second microcontroller unit is configured to control an indicator to indicate the selected charge mode.

In some embodiments, the first charge mode includes a charging current limited to 3 Amps. In some embodiments, the first charge mode includes a charging current limited to 6 Amps. In some embodiments, the first microcontroller unit is configured to unidirectionally communicate with the second microcontroller unit via the opto-isolation circuit. In some embodiments, the first microcontroller unit is configured to bidirectionally communicate with the second microcontroller unit via the opto-isolation circuit. In some embodiments, the first microcontroller unit controls a first power supply for the battery charger and the second microcontroller controls a second power supply of the battery charger, and the first power supply and the second power supply are electrically isolated within the battery charger. In some embodiments, the indicator indicates a fast charge mode as the selected charge mode. In some embodiments, the indicator indicates at least a subset of the plurality of battery pack interfaces are charging a connected battery pack using a fast charge mode. In some embodiments, the power tool battery pack charger further includes an input mechanism configured to generate the signal. In some embodiments, the indicator is positioned on a surface of a housing of the battery charger, and, in some embodiments, the second microcontroller unit is configured to control the indicator to indicate interruption of communication with the first microcontroller unit. In some embodiments, the opto-isolation circuit includes an optocoupler.

Other embodiments provide a method of operating a battery charger configured to charge a plurality of battery packs. The method includes controlling, via a first microcontroller unit included in the battery charger, a charge operation of at least a first one of the plurality of battery packs based on a selected charge mode and communicating, via an opto-isolation circuit included in the battery charger, the selected charge mode to a second microcontroller unit included in the battery charge. The method also includes controlling, via the second microcontroller unit, a charge operation of at least a second one of the plurality of battery packs based on the selected charge mode.

Further embodiments provide a system for controlling a charge mode of a battery charger. The system includes a first microcontroller unit configured to charge a first battery pack via a first power source, and a second microcontroller unit configured to charge a second battery pack via a second power source, wherein the second power source electrically isolated from the first power source. The system also includes an opto-isolation circuit and an input mechanism. The first microcontroller unit is configured to receive a signal output by the input mechanism, wherein the signal represents a selected charge mode, and control charging of the first battery pack via the first power source based on the selected charge mode. The first microcontroller unit is also configured to communicate the selected charge mode to the second microcontroller unit via the opto-isolation circuit.

Before any embodiments are explained in detail, it is to be understood that the embodiments are not limited in their application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

Unless the context of their usage unambiguously indicates otherwise, the articles “a,” “an,” “the,” and “said” should not be interpreted as meaning “one” or “only one.” Rather these articles should be interpreted as meaning “at least one” or “one or more” and may be used interchangeably with “a,” “an,” “the,” and “said” without implying a different meaning.

Also, it should be understood that the illustrated components, unless explicitly described to the contrary, may be combined or divided into separate software, firmware and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively. Similarly, a component described as performing particular functionality may also perform additional functionality not described herein. For example, a device or structure that is “configured” in a certain way is configured in at least that way but may also be configured in ways that are not explicitly listed.

Other aspects of the invention will become apparent by consideration of the detailed description and accompanying drawings.

### BRIEF DESCRIPTION OF THE DRAWINGS

FIG. 1A is a perspective view of a multi-bay battery charger according to some embodiments described herein.

FIG. 1B is a top view of another multi-bay battery charger according to some embodiments described herein.

FIG. 2 is a perspective view of a battery pack charged via the multi-bay battery charger of FIG. 1A or 1B according to some embodiments described herein.

FIG. 3 is a block diagram of a control system of the charger of FIG. 1A or 1B according to some embodiments described herein.

FIG. 4 is a block diagram of a charge mode switching interface, according to some embodiments described herein.

FIG. 5 is a block diagram of an alternative charge mode switching interface, according to some embodiments described herein.

FIG. 6 is a schematic illustration of the charge mode switching interface of FIG. 4 or 5, according to some embodiments described herein.

FIG. 7 is a process of charge mode selection using the charge mode switching interface of FIG. 4 or 5, according to embodiments described herein.

### DETAILED DESCRIPTION

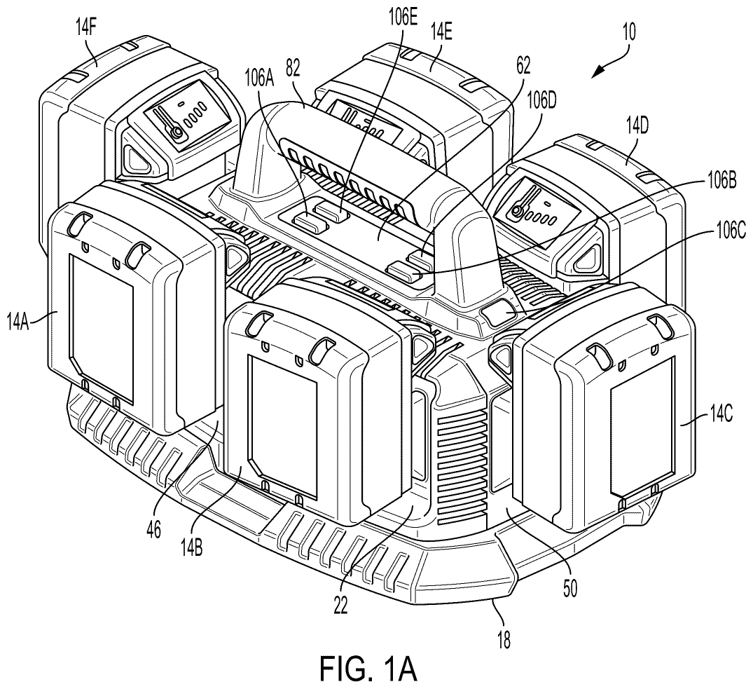

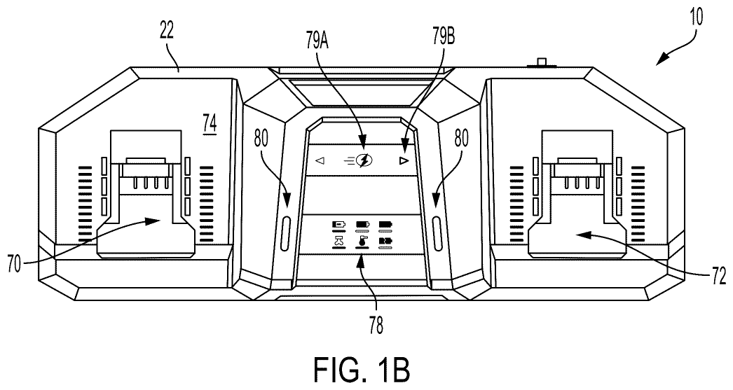

FIG. 1A illustrates a battery charger 10 configured to support and charge multiple battery packs 14A-F via a plurality of battery pack interfaces, wherein such a battery charger 10 may be referred to herein as a “multi-bay” battery charger referencing the multiple battery pack interfaces. In the illustrated embodiment, the battery charger 10 supports and charges up to six battery packs 14A-F. In other embodiments, the battery charger 10 is configured to support and charge fewer or more battery packs 14A-F. The battery packs 14A-F are, for example, 18-volt Li-ion power tool battery packs. In other embodiments, the battery packs 14A-F may have different voltages (e.g., 8-volt, 12-volt, 16-volt, 28-volt, 48-volt, etc.) and/or different chemistries (e.g., NiMH, NiCd, etc.). The illustrated charger 10 includes a base 18 and a housing 22. The base 18 is coupled to a bottom portion of the housing 22. The base 18 is generally larger (e.g., wider and longer) than the housing 22 to add stability to the charger 10.

The housing 22 extends outwardly from the base 18 and includes four side surfaces 46, 50 (side surfaces 54, 58 are not shown but each would be positioned opposite to one of the side surfaces 46 and 50) and an upper surface 62. The side surfaces 46, 50, 54, 58 are arranged perpendicular to one another in a generally rectangular pattern. The upper surface 62 is spaced apart from the base 18 and extends generally perpendicular to the side surfaces 46, 50, 54, 58. In some embodiments, the housing 22 is composed of two clamshell halves that connect to define the surfaces 46, 50, 54, 58, 62 of the housing 22. The clamshell halves thereby enclose the interior components of the charger 10. In other embodiments, the housing 22 may be formed as a single piece connected to the base 18.

The side surfaces 46, 50, 54, 58 are generally vertically oriented when the charger 10 is supported by the base 18 on a surface. In some embodiments, each side surface 46, 50, 54, 58 supports at least one of the battery pack interfaces. In other embodiments, one or more of the side surfaces 46, 50, 54, 58 may support two or more battery pack interfaces. Also, in some embodiments, the charger 10 may include only a single battery pack interface for charging a single battery pack. Accordingly, embodiments described herein are not limited to multi-bay chargers.

In the illustrated embodiment, the housing 22 also includes a handle 82 extending from the upper surface 62. The handle 82 is centrally positioned on the charger 10 such that a central axis defined by the side surfaces 46, 50, 54, 58 of the housing 22 extends through the handle 82. The handle 82 defines a longitudinal axis generally parallel to the side surfaces 46, 54 and generally perpendicular to the side surfaces 50, 58. The handle 82 thereby defines an elongated grip generally parallel to and spaced apart from the upper surface 62 to facilitate lifting and carrying the charger 10.

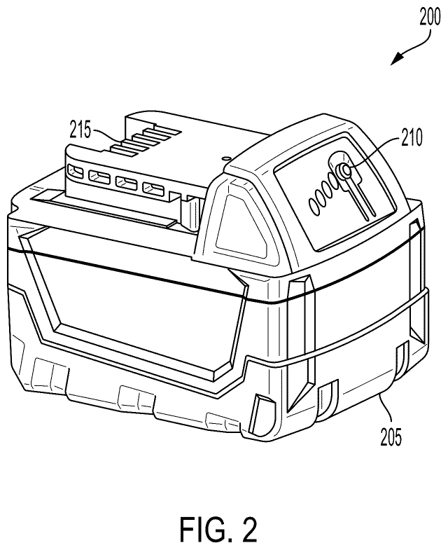

In some embodiments, each of the battery pack interfaces of the charger 10 includes a connecting structure and electrical contacts. In some embodiments, the connecting structures include one or more guide rails configured to receive slide-on style battery packs (FIG. 2). In other embodiments, the connecting structures may be configured to receive different styles of battery packs, such as, for example, tower style battery packs.

In some embodiments, the electrical contacts of the battery pack interfaces of the charger 10 are coupled to a charging circuit. The charging circuit is positioned within the housing 22 and charges the battery packs 14A-F when the packs 14A-F are connected to the battery pack interfaces.

In the illustrated embodiment, the battery charger 10 also includes one or more indicator lights 106A-F, which may be coupled to the charging circuit. The illustrated indicator lights 106A-F are light-emitting diodes (LEDs). As shown in FIG. 1A, the LEDs 106A-F may extend from the upper surface 62 of the housing 22. In some embodiments, each battery pack interface of the charger 10 may be associated with one or more indicator lights and, therefore, each indicator light may indicate an operational status of the associated battery pack interface. The indicators may be controlled to provide various visual indicators (e.g., various colors, icons or symbols, text, blinking patterns, etc.) of the operational status of a battery pack interface. For example, a continuous red light output via an indicator light may indicate the battery pack connected to the associated battery pack interface is charging, a continuous green light output via an indicator may indicate charging is complete for the battery pack connected to the associated battery pack interface, and flashing red and/or green lights output via an indicator may indicate an error associated with the battery pack connected to the associated battery pack interface or the battery pack interface itself. In some examples, in response to a battery pack being connected to a battery pack interface while another battery pack is already being charged via one of the other battery pack interfaces, one of the indicator lights (e.g., a red LED) may flash to indicate that charging is pending and will begin when the other battery pack is finished charging. Additionally or alternatively, indicator lights may be configured to indicate a charging rate of one or more of the battery packs.

As described in more detail below, in some embodiments, the charger 10 includes a user interface for receiving user input adjusting parameter settings related to charging one or more of the battery packs 14A-F (i.e., one or more of the battery pack interfaces). The user interface may include one or more input mechanisms, such as, for example, a screen (e.g., touchscreen), one or more buttons, knobs, or the like, or a combination thereof. The user interface may be positioned on one or more surfaces of the housing 22, such as, for example, the upper surface 62.

It should be understood that the multi-bay battery charger 10 may take various forms (e.g., sizes and shapes) and configurations. For example, FIG. 1B illustrates another embodiment of the multi-bay battery charger 10 configured to support and charge multiple battery packs 14A-F (not shown) via a plurality of battery pack interfaces in accordance with some embodiments. The charger 10 illustrated in FIG. 1B includes a first battery pack interface 70 and a second battery pack interface 72. In this example, both interfaces 70 and 72 are positioned on a top surface 74 of the housing 22 of the charger 10. However, other positions and configurations of the interfaces 70 and 72 may be used. In some embodiments, each of the battery pack interfaces 70 and 72 of the charger 10 includes a connecting structure and electrical contacts. In some embodiments, the connecting structures include one or more guide rails configured to receive slide-on style battery packs (see FIG. 2). In other embodiments, the connecting structures may be configured to receive different styles of battery packs, such as, for example, tower style battery packs. Also, although the charger 10 illustrated in FIG. 1B includes two battery pack interfaces 70 on the same surface of the housing 22, the charger 10 may include more than two interfaces and the interfaces may be positioned at various locations and on various surfaces of the housing 22.

As illustrated in FIG. 1B, charger 10 also includes one or more indicator lights 78 (similar to the lights 106A-F described above with respect to the charger 10 illustrated in FIG. 1A), which may be coupled to the charging circuit. The indicator lights 78 may be light-emitting diodes (LEDs) and may be positioned on the top surface 74 of the housing 22. In some embodiments, each battery pack interface 70 and 72 of the charger 10 may be associated with one or more indicator lights, and each indicator light may indicate an operational status of the associated battery pack interface. For example, a continuous red light output via an indicator light may indicate the battery pack connected to the associated battery pack interface is charging, a continuous green light output via an indicator may indicate charging is complete for the battery pack connected to the associated battery pack interface, and flashing red and/or green lights output via an indicator light may indicate an error associated with the battery pack connected to the associated battery pack interface or the battery pack interface itself. Again, it should be understood that the indicator lights may provide indications in various forms, such as via colors, text, icons or symbols, blinking patterns, and the like. In some examples, in response to a battery pack being connected to a battery pack interface while another battery pack is already being charged via one of the other battery pack interfaces, one of the indicator lights (e.g., a red LED) may flash to indicate that charging is pending and will begin when the other battery pack is finished charging. Additionally or alternatively, indicator lights may be configured to indicate a charging rate of one or more of the battery packs. For example, in some embodiments, the charger 10 is configured to provide a fast charge current to the one or more interfaces 70 and 72 and may provide the fast charge current automatically, in response to user input, or a combination thereof. The fast charge current has a value (e.g., a 9 Amp charging current) that is greater than a standard charge current value (e.g., a 6 Amp charging current). When the charger 10 is providing the fast charge current to the one or both of the interfaces 70 and 72, the charger 10 may activate a first indicator 79A (e.g., a lightning bolt is illuminated) to indicate that the charger 10 is fast charging a battery pack. In some embodiments, a second indicator 79B (e.g., an arrow) is activated to indicate which of the interfaces 70 and 72 is receiving the fast charge current.

As described in more detail below and as illustrated in FIG. 1B, in some embodiments, the housing 22 (e.g., a top surface 74 of the housing 22) of the charger 10 also includes one or more user interfaces for receiving user input adjusting parameter settings related to charging one or more of the battery packs being charged by the charger 10. The one or more user interfaces may include one or more input mechanisms, such as one or more screens (e.g., touchscreen), one or more buttons, knobs, or the like, or a combination thereof. For example, as illustrated in FIG. 1B, in some embodiments, the charger 10 includes a button 80 for each interface 70 and 72, wherein a user can select (e.g., push, slide, toggle, etc.) the button 80 to manually control charging provided by the respective interface (e.g., start or stop charging, change a charge mode, or the like). For example, in some embodiments, the charger 10 may include separate power supplies for each interface 70 and 72, wherein the power supplies are electrically isolated from each other and are controlled by separate controllers. Accordingly, in this configuration, a separate button 80 may be provided for each interface 70 and 72. As described in more detail below, in some embodiments, only a single button 80 is provided for controlling charging (e.g., controlling or selecting a charge mode). The button(s) 80 may include a push button and may allow a user to manually switch between different charge modes.

The user interface(s), including the button(s) 80 illustrated in FIG. 1B, allow a user to manually control a charge mode implemented via the charger 10. For example, during particular times of the day (e.g., at night) when multiple chargers are plugged in, there is a risk that using a fast charge mode with a particular charger may trip a breaker or negatively impact power usage. Accordingly, in this situation or other situations where there is sufficient time to perform battery charging, a user may use the user interfaces to manually switch to a slower or lower charge mode (e.g., a 3 Amp charge mode).

In some embodiments, in addition to providing manual control of charging, the charger 10 may charge the battery packs 14A-F automatically using various parameters. For example, in some embodiments, the charger 10 may charge the battery packs 14A-F in series such that one battery pack 14A-F is charged at a time. Accordingly, in such implementations, the charger 10 may be referred to as a “sequential charger.” The charging circuit in a sequential charger may cycle serially through the battery pack interfaces to determine parameters regarding the battery packs 14A-F that are connected to each interface. These parameters may include the presence of a battery pack and which, if any, of the battery packs require charging (e.g., based on a current state of charge of the battery pack). In response to detecting that more than one battery pack connected to the charger 10 requires charging, the charging circuit sequentially charges the battery packs in order from the battery pack connected to the lowest (e.g., with respect to a physical position on the charger 10) battery pack interface (e.g., a first battery pack interface) to the battery pack connected to the highest battery pack interface (e.g., a sixth battery pack interface). In response to finishing charging of a battery pack connected to a particular battery pack interface, the charging circuit starts charging the battery pack connected to the sequentially next (i.e., based on physical position) battery pack interface. The charger 10 repeats this process until no connected battery packs remain that need charging. In response to not detecting a connected battery pack at one of the battery pack interfaces or if a battery pack and/or battery pack interface is experiencing an error, the charging circuit may skip that particular interface and move on to the next sequential battery pack interface. It should be understood that other sequences may be used to perform charging and such sequential charging is not limited to moving from a lowest (positionally-wise) battery pack interface to a highest (positionally-wise) battery pack interface as any particular sequence may be applied by the charger 10. Also, alternatively or in addition, in some embodiments, the charger 10 can charge one or more the battery packs 14A-F simultaneously such that one or more connected battery packs are charged at the same time.

In some embodiments, the charger 10 determines additional parameters (e.g., regarding the battery packs 14A-F, the operating environment of the charger, the charger 10, or a combination thereof) and may optimize charging operations accordingly (e.g., rather than performing a simple sequential charging sequence). For example, the parameters can include a charger rate/current, a state of charge to end charging (e.g., a state of charge set point of a battery that stops charging), ambient temperature, battery temperature, battery capacity, battery voltage, battery condition/age, battery charging characteristics, battery chemistry, maximum charging current of battery, number of batteries on one charger, number of batteries on one power outlet, number of batteries on multiple connected devices, maximum available AC power, or a combination thereof. The charger 10 uses the parameters to generate a charging configuration that provides the operational settings for the charger 10 and/or the battery packs 14A-F.

In some embodiments, in addition to or separate from the battery parameters, charger parameters, and environment parameters described above, the charger 10 is configured to use one or more user-defined settings to generate a charging configuration. The charger 10 may use the user-defined settings in combination with other parameters when generating a charging configuration (e.g., parameters of the battery pack interfaces, battery packs, operating environment of the charger 10, and/or the charger 10) or, alternatively, may use a user-defined setting as an override for other parameters. The user-defined settings allow a user to configure the charger 10 to meet their needs and use scenarios and manage (e.g., adjust) battery cycle life as compared to being forced to accept default charging parameters set by a manufacturer or supplier (e.g., of a battery pack). The user-defined settings may include a maximum charger rate/current, a state of charge to end charging, and the like. For example, setting a charge rate may allow multiple chargers to be connected to a single outlet (e.g., 120V AC outlet) and throttle charger rates to allow for simultaneous charging. Similar control may be used for a sequential charger to allow for simultaneous charging of battery packs connected to the charger. Also, setting a state of charge to end charging allows charging to be stopped in response to a battery state of charge reaching a set point, such as, for example, 70%, 75%, 80%, 85%, 90%, 95%, 98%, or the like. Thus, the user-defined settings allow a user to choose if they want to get full capacity from their battery pack or stop charging earlier to potentially extend the life of their battery pack. Similarly, a user-defined setting can include a maximum charge rate and/or current, which may be used to extend battery life; a maximum battery voltage, which may also be used to extend battery life; a preferred charging sequence for a plurality of chargers or a plurality of battery pack interfaces on a charger (e.g., charge two battery packs to maximum capacity as quick as possible and charge the other connected batteries at a slower rate, set a sequence or order for charging battery packs, charge available batteries to maximum capacity in the shortest possible time, etc.), or the like.

FIG. 2 illustrates a battery pack 200, which is representative of the battery packs 14A-F of FIG. 1A. The battery pack 200 includes a housing 205, a user interface portion 210 for providing a state-of-charge indication for the battery pack 200, and a device interface portion 215 for connecting the battery pack 200 to a device, such as for example, a power tool or the charger 110. In some embodiments, the battery pack 200 includes a plurality of battery cells within the housing 205. In other embodiments, the battery pack 200 includes a communication interface and a memory that includes default and/or user-defined parameters (e.g., battery parameters, environmental parameters) of a charging configuration. In some embodiments, the battery pack 200 can provide the stored settings of parameters to the charger 10 for charging according to the charging configuration (e.g., via the communication interface), and the stored user-defined parameters may be initially received from the charger 10 or a separate device. For example, similar to how a remote device may communicate with the charger 10 to provide user-defined settings, user-defined settings may be communicated from a remote device directly to a battery pack (e.g., using a communication interface of the battery pack).

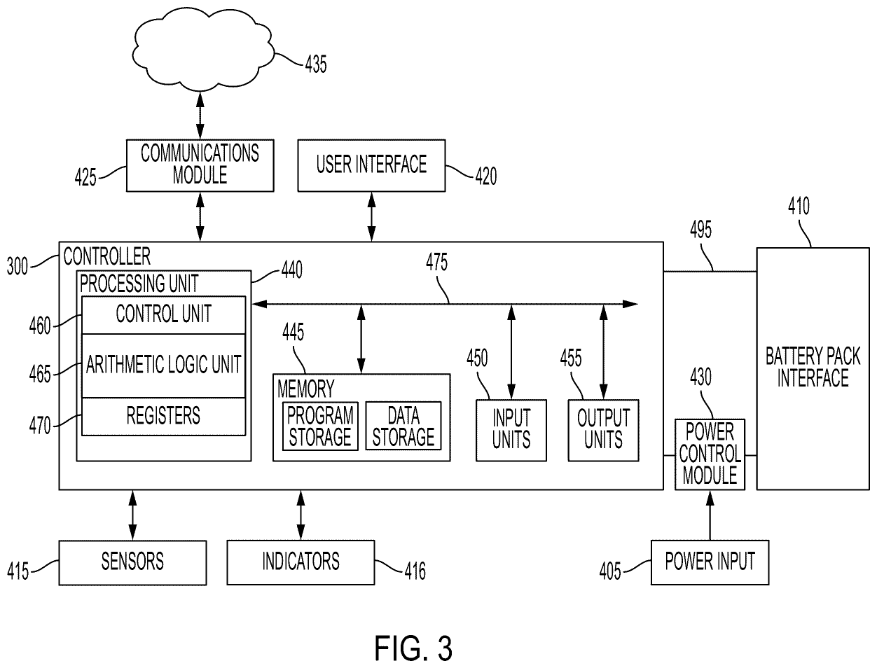

FIG. 3 schematically illustrates a control system for the charger 10. The control system includes a controller 300. The controller 300 is electrically and/or communicatively connected to a variety of modules or components of the charger 10. For example, the illustrated controller 300 is electrically connected to a battery pack interface 410, one or more sensors or sensing circuits 415, one or more indicators 416, a user interface 420, a communications controller or interface 425, and a power control module 430. The controller 300 includes combinations of hardware and software that are operable to, among other things, control the operation of the charger 10, monitor the operation of the charger 10, activate the one or more indicators 416 (e.g., an LED), etc.

The controller 300 includes a plurality of electrical and electronic components that provide power, operational control, and protection to the components and modules within the controller 300, the charger 10, and/or the battery pack 200. For example, the controller 300 includes, among other things, a processing unit 440 (e.g., a microprocessor, a microcontroller, an electronic processor, an electronic controller, or another suitable programmable device), a memory 445, input units 450, and output units 455. The processing unit 440 includes, among other things, a control unit 460, an arithmetic logic unit (ALU) 465, and a plurality of registers 470 (shown as a group of registers) and is implemented using a known computer architecture (e.g., a modified Harvard architecture, a von Neumann architecture, etc.). The processing unit 440, the memory 445, the input units 450, and the output units 455, as well as the various modules or circuits connected to the controller 300 are connected by one or more control and/or data buses (e.g., common bus 475). The control and/or data buses are shown generally in FIG. 3 for illustrative purposes. The use of one or more control and/or data buses for the interconnection between and communication among the various modules, circuits, and components would be known to a person skilled in the art in view of the invention described herein.

The memory 445 is a non-transitory computer readable medium and includes, for example, a program storage area and a data storage area. The program storage area and the data storage area can include combinations of different types of memory, such as a read only memory (“ROM”), a random access memory (“RAM”) (e.g., dynamic RAM [“DRAM”], synchronous DRAM [“SDRAM”], etc.), electrically-erasable programmable ROM (“EEPROM”), flash memory, a hard disk, an SD card, or other suitable magnetic, optical, physical, or electronic memory devices. The processing unit 440 is connected to the memory 445 and is configured to execute software instructions that are capable of being stored in a RAM of the memory 445 (e.g., during execution), a ROM of the memory 445 (e.g., on a generally permanent basis), or another non-transitory computer readable medium such as another memory or a disc. Software included in the implementation of the charger 10, the battery pack 200, and controller 300 can be stored in the memory 445 of the controller 300. The software includes, for example, firmware, one or more applications, program data, filters, rules, one or more program modules, and other executable instructions. The controller 300 is configured to retrieve from the memory 445 and execute, among other things, instructions related to the control processes and methods described herein. In other embodiments, the controller 300 includes additional, fewer, or different components.

The battery pack interface 410 includes a combination of mechanical components (e.g., rails, grooves, latches, etc.) and electrical components (e.g., one or more terminals) configured to and operable for interfacing (e.g., mechanically, electrically, and communicatively connecting) the charger 10 with a battery pack (e.g., the battery pack 200). For example, power provided by the charger 10 to the battery pack 200 is provided from a power input 405 through the power control module 430 to the battery pack interface 410. The power control module 430 includes combinations of active and passive components to regulate or control the power received from the power input 405 prior to power being provided to the controller 300. The battery pack interface 410 also supplies power from the power input 405 to the battery pack 200. The battery pack interface 410 also includes, for example, a communication line 495 for providing a communication line or link between the controller 300, the battery pack interface 410, and the battery pack 200.

The sensors 415 include, for example, one or more voltage sensors, one or more current sensors, one or more temperature sensors, and/or one or more additional sensors used for measuring electrical and/or other characteristics of the charger 10 and/or the battery pack 200. Each of the sensors 415 generates one or more output signals that are provided to the controller 300 for processing and evaluation. The indicators 416 include, for example, one or more light-emitting diodes (“LEDs”). The indicators 416 can be configured to display conditions of, or information associated with, the charger 10. For example, the indicators 416 are configured to indicate measured electrical characteristics of the charger 10, the status of the charger 10, etc. The indicators 416 may also include the indicator lights 106A-F and 78 as described above with respect to FIGS. 1A and 1B.

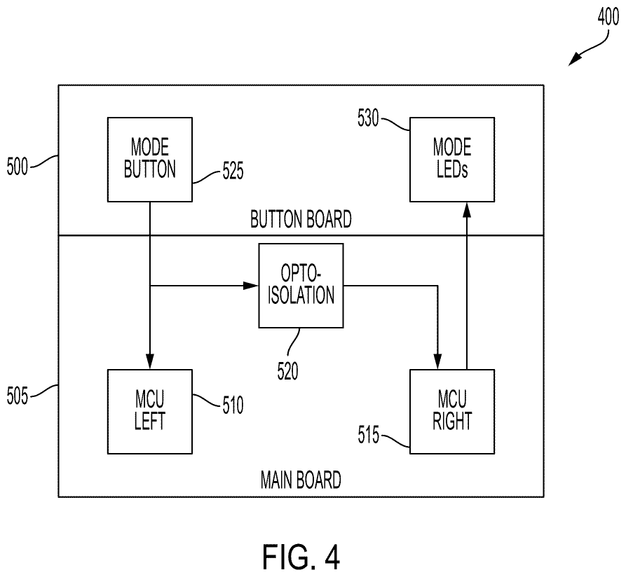

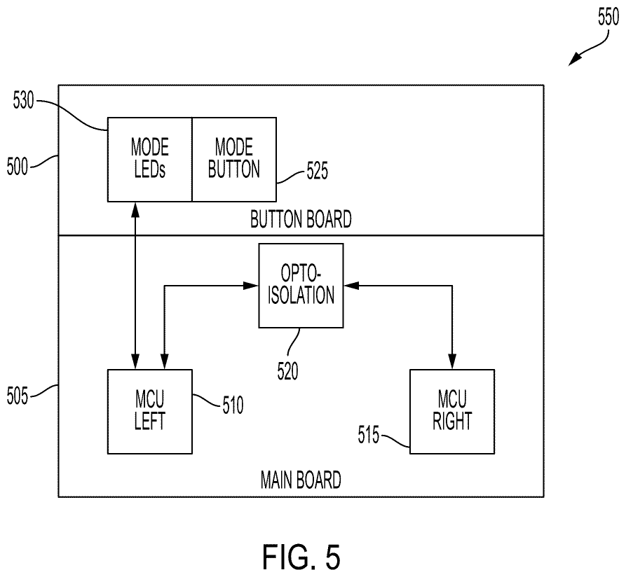

The user interface 420 is operably coupled to the controller 300 and receives user input including, for example, a selection of a mode of operation (charge mode selection), an adjustment a charger parameter setting (i.e., one or more user-defined settings as described above), or a combination thereof. In some embodiments, the user interface 420 includes a combination of digital and analog input or output devices required to achieve a desired level of operation for the charger 10, such as one or more knobs, one or more dials, one or more switches, one or more buttons, etc. The user interface 420 may include the user interfaces described above with respect to FIGS. 1A and 1B, such as, for example, the button(s) 80. In some embodiments, the user interface 420 is integrated with a display (e.g., as a touchscreen display). In some examples, the user interface 420 includes a button board 500, as illustrated in FIGS. 4-5 and detailed below. The button board 500 includes a mode button 525 for selecting a mode of operation, and a mode LED 530 for indicating the selected mode of operation. In some examples, the mode LED 530 is included in the indicator lights 106A-F and 78 as described above with respect to FIGS. 1A and 1B. In other examples, the mode LED 530 is separate from the indicator lights 106A-F.

The controller 300 is configured to implement a charging configuration by determining whether a particular condition is present and generate one or more control signals related to the condition. For example, the sensing circuits 415 include one or more current sensors, one or more voltage sensors, one or more temperature sensors, etc., and the controller 300 receives data from the sensing circuits 415, which the controller 300 uses to detect whether a particular condition is present. The controller 300 calculates or includes, within memory 445, predetermined operational threshold values and limits for operation of the charger 10 and/or a battery pack connected to the charger 10, which the controller 300 may compare to data from the sensing circuits 415 (or data derived from such data) to detect or predict (e.g., using static rules, historical data, machine learning, or the like) a condition. For example, in response to detecting or predicting an out-of-range temperature (e.g., of a battery pack connected to the charger 10, etc.), the controller 300 may limit or interrupt power to the connected battery pack (through the power control module 430) until the temperature is reduced.

The communications interface 425 can communicate with a network 435 and enables the controller 300 to communicate with one or more peripheral (remote) devices also connected to the network 435, such as, for example, a smartphone, a tablet computer, a smart wearable device, other charging devices, a server, or a combination thereof. As described in more detail below, the controller 300 includes combinations of hardware and software that are configured to, among other things, control the operation of the power control module 430 and the associated power input 405, communicate over the network 435, receive input from a user via the user interface 420, provide information to a user via user interface 420 (e.g., a display), etc.

Although the controller 300 is illustrated in FIG. 3 as one controller, the controller 300 may include multiple controllers configured to work together to achieve a desired level of control for the charger 10. As such, any control functions and processes described herein with respect to the controller 300 could also be performed by two or more controllers functioning in a distributed manner, wherein the two or more controllers perform the control functions and processes described herein collectively as a set. For example, as noted above, in some embodiments, the charger includes separate power supplies for different battery pack interfaces or groups of battery pack interfaces and the power supplies may be electrically isolated from each other and controlled by separate controllers. In such an embodiment, the controller 300 may include a main board (a printed circuit board) 505 as illustrated in FIGS. 4-5 and described below. The main board 505 may include one or more microcontroller units (MCU), such as a left MCU 510 and a right MCU 515. In some examples, each MCU 510, 515 may be responsible for charging different battery packs 200 connected to the charger 10 using power, for example, from different, electrically isolated power sources. During operation of the charger 10, the MCUs 510, 515 (or, alternatively, the controller 300) is configured to monitor voltage, current, and/or other signals received from the various components described above. More generally, the MCUs 510, 515 are configured to monitor and/or control power flow to and from the above-described components of the charger 10 that are electrically and communicatively coupled to the charger 10.

As also noted above, in some embodiments, the MCUs 510 and 515 may not communicate and, thus, separate buttons or other user interfaces may be provided on the charger 10 to control charging provided via a particular interfaces or subset of interfaces. Alternatively, in some embodiments, a single button may be provided for controlling charging (e.g., switch the maximum charge rate) for multiple (e.g., both) power supplies. Accordingly, in this configuration, the MCUs 510 and 515 need to communicate while maintaining electrical isolation.

FIG. 4 is a block diagram of a charge mode switching interface 400 of the charger 10 according to some embodiments, wherein the interface 400 provides a single button for controlling multiple power supplies used by the charger 10. As illustrated in FIG. 4, the charge mode switching interface 400 includes a main board 505 including a first (e.g., left) MCU 510, a second (e.g., right) MCU 515, and an octo-isolator (also referred to as opto-isolation circuit 520). An opto-isolator (also called an optocoupler, photocoupler, or optical isolator) is an electrical component that transfers electrical signals between two isolated circuits using light and, thus, prevent high voltages from affecting the system receiving the signal. An opt-isolator may include an LED and a phototransistor within an opaque package, but other combinations are possible (e.g., an LED-photodiode, an LED-LASCR, or a lamp-photoresistor pair).

As illustrated in FIG. 4, the charge mode switching interface 400 also includes a button board 500 including a mode button 525 and a mode LED 530. In some examples, the charging rate of the charger 10 may be selected by a user via the mode button 525. For example, when the mode button 525 is pressed, a mode select signal is output from the mode button 525 and input to the left MCU 510. The MCU 510 is configured to, in response to receiving the mode select signal, output a control signal to the opto-isolation circuit 520. The control signal drives the opto-isolation circuit 520 (e.g., drives an LED of the circuit 520), that in turn drives a (e.g., digital) input signal to the right MCU 515.

The mode/charge rate the charger 10 may be communicated as a constant high or low signal or a modulated signal (e.g., a series of “tones”) indicating the selected charge mode. For example, a 1 Hz signal may be associated with a first charge mode, a 2 Hz signal may be associated with a second charge mode, and the like. It should be understood that various frequencies may be used and, in some embodiments, more than two charge modes may be available and additional frequencies may be used to designate one of the available modes. It should also be understood that different data may be communicated between the left MCU 510 and the right MCU 515 to indicate a selected charge mode. For example, the communicated data may include an identifier of a mode, an identifier of a charge rate, or a combination thereof.

In some examples, the left MCU 510 is configured as a “primary” MCU and controls a first power supply, and the right MCU 515 is configured as a “secondary” MCU and controls a separate power supply, and the opto-isolation circuit 520 allows the left MCU 510 to communicate with right MCU 515 while remaining electronically isolated from one another.

In some examples, such as the example illustrated in FIG. 4, the communication between the MCUs 510, 515 is unidirectional. For example, the left MCU 510 may communicate the control signal to the right MCU 515, but the right MCU 515 may not communicate a signal back to the left MCU 510. When the communication is implemented as unidirectional, the right MCU 515 may also be configured to control the mode LED 530 to flash a fault code if the right MCU 515 stops receiving communication. For example, in a situation where the left MCU 510 controls the LED 530, the left MCU 510 may not be able to identify whether communication with the right MCU 515 has been interrupted (i.e., based on the unidirectional communication). In some examples, the mode button 525 is configured to output the mode select signal to the left MCU 510 and is also configured to output a control signal to the opto-isolation circuit 520.

FIG. 5 is a block diagram of an alternative configuration of the charge mode switching interface 550, according to some embodiments described herein. Similar to the charge mode switching interface 400 as described in FIG. 4, the alternative configuration illustrated in FIG. 5 includes a main board 505 including the MCU 510, the MCU 515, and the opto-isolation circuit 520. However, in this configuration, the communication between the MCUs 510, 515 is bidirectional. As illustrated in FIG. 5, in the interface 550, the left MCU 510, as the primary MCU, may receive input from the mode button 525 and also control the LED 530 as the left MCU 510 can use the bidirectional communication to confirm or track communication with the right MCU 515.

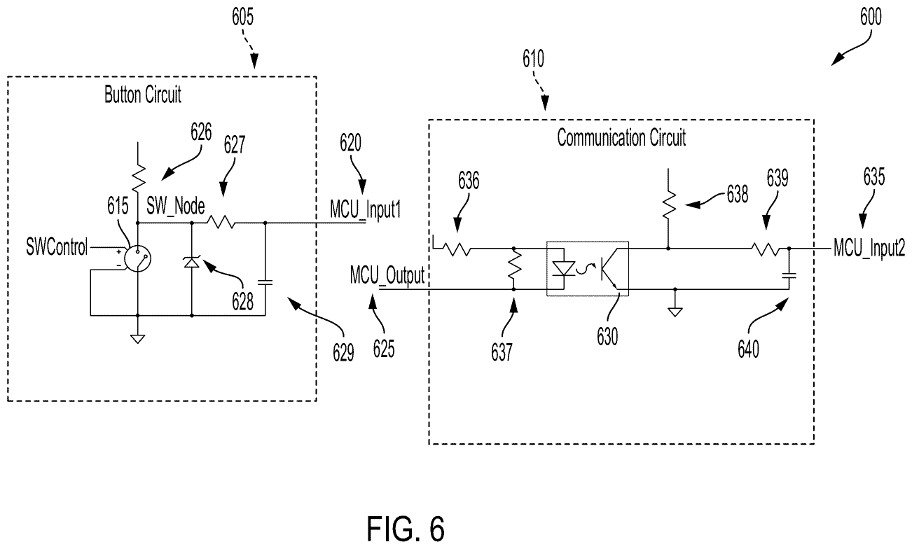

FIG. 6 is a schematic 600 of the charge mode switching interfaces 400 or 550, according to some embodiments. The schematic 600 includes a button circuit 605 and a communication circuit 610. The button circuit 605 includes a switch 615 configured to generate a mode select signal, wherein the switch 615 is included as part of the mode button 525 described above. The mode select signal is then transmitted as an MCU input 620 to the left MCU 510 (not illustrated in FIG. 6). As illustrated in FIG. 6, the button circuit 605 may also include a resistor 626 (e.g., a 10k Ohm resistor) positioned on a power line (e.g., a 5 volt power line), a resistor 627 (e.g., a 1k Ohm resistor), a diode 628, and a capacitor 629 (e.g., a 0.1μ capacitor). It should be understood that other circuit configurations may also be used to obtain an input representing a selected charge mode and communicate the selected charge mode to the MCU 510 and the configuration illustrated in FIG. 6 is provided as one example.

The left MCU 510 is configured to output the control signal as MCU output 625 to optocoupler 630, which is included as part of the opto-isolation circuit 520 described above and the communication circuit 610 illustrated in FIG. 6. The optocoupler 630 is configured to transmit the control signal to the right MCU 515 (not shown) as MCU input 635. As illustrated in FIG. 6, the communication circuit 610 may also include a resistor 636 (e.g., a 1.58k Ohm resistor) positioned on a power line (e.g., a 5 volt power line), a resistor 637 (e.g., a 10k Ohm resistor), a resistor 638 (e.g., a 10k Ohm resistor) positioned on a power line (e.g., a 5 volt power line), a resistor 639 (e.g., a 1k Ohm resistor), and a capacitor 640 (e.g., a 0.1μ capacitor). It should be understood that the circuitry configuration of the communication circuit 610 illustrated in FIG. 6 is provided as one example and other circuit configurations may be used to communicate the selected charge mode to the right MCU 515 while maintaining electrical isolation of the MCUs 510 and 515 and the power sources controlled by each MCU.

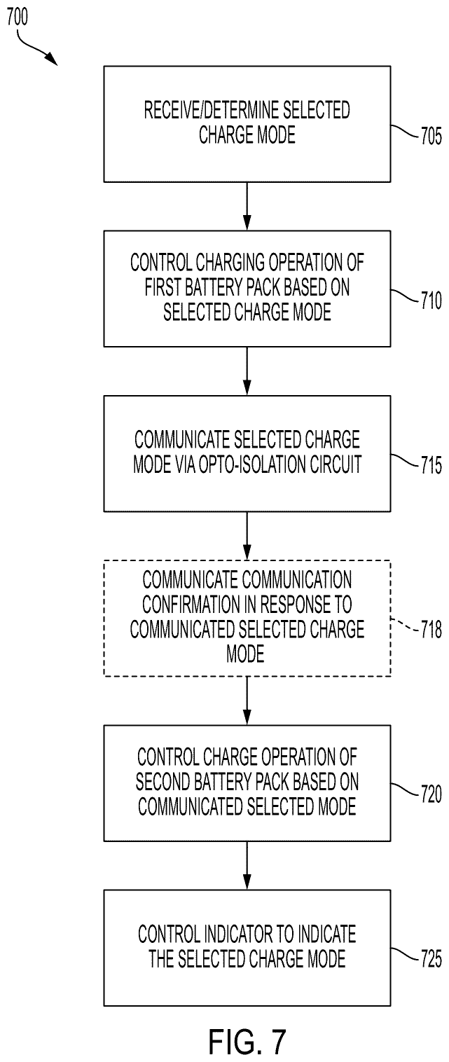

FIG. 7 is a flowchart illustrating a process 700 for selecting a charge mode using the charge mode switching interfaces 400 or 550, according to some embodiments described herein. The process 700 may be executed by the charger 10 to charge one or more battery packs 200. The process 700 includes receiving and/or determining a selected charge mode (block 705). As described above, in some embodiments, an input signal received from an input mechanism may indicate the selected charge mode. For example, a signal from a mode selection button, such as, for example, the mode button 525 may represent a selected charge mode and may be received at the left MCU 510 (e.g., the primary MCU). The charge mode may be, for example, a slow charge mode or a fast charge mode. In some examples, the slow charge mode may limit a current provided to the battery pack to 3 Amps, and the fast charge mode may limit the current provided to the battery pack to 6 Amps. In some examples, the current limit for either the slow charge mode or the fast charge mode may be another current limit. For example, the slow charge mode may alternatively be limited to a current between 1 Amp and 3 Amps, and the fast charge mode may be limited to a current between 1 Amp and 12 Amps. While the mode button 525 is described herein as being usable to select a charge mode for each power supply used by the charger 10, the mode button 525 (or a similar user input/interface) may be usable to select a charge mode configuration, wherein different charge modes may be selected for different power supplies and/or different charging interfaces (batteries). For example, a user may select two battery packs to charge with a slow charge mode and third battery pack to charge with a fast charge mode. In some embodiments, different buttons or other user inputs/interfaces may be provided for selecting such a mode configuration. Alternatively or in addition, the mode button 525 may allow a user to cycle through available configurations and select one of the configurations.

Although the mode selection is described herein as being based on the mode button 525 (or a similar type of user input/interface), in some embodiments, the charger 10 (e.g., the left MC 510) is configured to automatically determine or select a charge mode. The automatic selection of the charge mode may be determined based on one or more battery pack parameters, charger parameters, and operating environment parameters, such as, for example, battery pack voltages, battery pack temperatures, condition/age of battery packs, charge capacity of battery packs, ambient temperature, maximum available power, time left in bulk charge of a charger (e.g., time is based on the remaining power needed for a battery pack), current charger settings (e.g., charger configurations), a time of day, a number of batteries connected to the charger 10, or the like. For example, the charger 10 may be configured to select a fast charge mode when a battery pack temperature is at or below 60° C., and configured to select a slow charge mode when the battery pack temperature is above 60° C. as determined by the sensing circuits 415. Accordingly, it should be understood that block 705 may include receive a selected charge mode, automatically determining a selected charge mode, or a combination thereof and, thus, the process 700 may operate similarly depending on whether a charge mode selection is received from a user input/interface or determined automatically. As noted above, in some embodiments, a charge mode or charge mode configuration may be automatically determined, and one or more user-input may also be received and applied to modify or override the determined charge mode or charge mode configuration. As also noted above, in some embodiments, one or more of the battery parameters may be communicated from the battery packs (e.g., battery pack age and/or condition, charge mode, etc.) or may be automatically determined using, for example, various sensors and sensing circuitry (e.g., battery temperature).

The process 700 also includes controlling a charging operation of a first battery pack based on the selected charge mode (e.g., sets a charging parameter based on the selected charge mode) (at block 710). As noted above, the primary MCU may receive the selected charge mode (selected via user input and/or automatically determined) and may control charging of a first battery pack (of a plurality of battery packs interfacing with the charger 10) based on the selected charge mode. The processor 700 also includes communicating the selected charge mode to another MCU included in the charger via the opto-isolation circuit 520 (block 715). For example, as described with respect to FIGS. 4 and 5, the mode button 525 communicates the selected charge mode to at least one MCU, such as left MCU 510 of the main board 505, and the left MCU 510 communicates the selected charge mode to the right MCU 515 via the opto-isolation circuit 520. As also previously described, the opto-isolation circuit 520 allows the MCUs 510 and 515 to communicate while keeping the power supplies and associated circuits established with the MCUs 510 and 515 electrically isolated.

Based on the communicated charge mode, each MCU receiving the communicated charged mode (which may include the second MCU or more than one MCU in embodiments where the charger 101 includes more than two MCUs) sets a charging parameter for controlling charging of another battery pack interfacing with the charger 10 (e.g., a second battery pack) based on the selected charge mode (block 720). For example, when a slow charge mode is selected/determined, a battery charging parameter is set to the selected slow charge mode (e.g., of 6 Amps). In this example, battery charging is defined as an operational range for the charger 10 based on the selected charge mode. In some embodiments, the controller 300 may store the selected charge mode (and/or the received settings) in the memory 445 of the charger 10.

As illustrated in FIG. 7, in some embodiments, when bidirectional communication is implemented via the opto-isolation circuit, a MCU receiving the communicated selected charge mode (e.g., the second MCU) may communicate a confirmation confirming receipt of the communicated selected charge mode (also referred to herein as a “communication confirmation”) (at block 718). This confirmation may be communicated to the main MCU to allow the main MCU to track and confirm communication to the MCUs and take appropriate action if there is a fault or error with the communication (e.g., a fault or error with the opto-isolation circuit) or with operation of the other MCUs or associated power supplies and charging operations.

The process 700 also includes controlling one or more indicators to indicate the selected charge mode (block 725). For example, the selected charge mode may be indicated on the mode LED 530. Additionally or alternatively, the selected charge mode may be indicated on another type of user output/interface on the charger 10 or remote from the charger 10. The selected charge mode may be indicated in various ways, such as, for example, turning on an LED, illuminating (activating) an icon, controlling an LED to output light in a particular color, pattern, or blink rate, or the like. As noted above, the mode LED 530 (and/or other indicators included in the charger 10) may also be controlled to indicate error conditions, power conditions, a state of charge of one or more of the connected battery packs 200, or the like. As described with respect to FIGS. 4 and 5, in some embodiments, the right or secondary MCU 515 is configured to control an indicator, such as the LED 530. However, in other embodiments, the left or primary MCU 510 is configured to control an indicator (e.g., when bi-directional communication is used). Also, in some embodiments, the right and left MCUs 510 and 515 may each be configured to control their own indicator(s).

Thus, the disclosure provides, among other things, methods and system for selecting a charge mode for a battery charging system. Various features and advantages of the disclosure are set forth in the following claims.

What is claimed is:

1. A power tool battery pack charger comprising:
a first microcontroller unit;
a second microcontroller unit; and
a plurality of battery pack interfaces for charging a plurality of battery packs,
the first microcontroller unit configured to:
receive a signal representing a selected charge mode, the selected charge mode including a first charging mode or a second charge mode,
control a charge operation of at least a first one of the plurality the battery packs based on the selected charge mode, and
communicate, via an opto-isolation circuit, the selected charge mode to the second microcontroller unit,
wherein at least one of the first microcontroller unit and the second microcontroller unit is configured to control an indicator to indicate the selected charge mode.

2. The power tool battery pack charger of claim 1, wherein the first charge mode includes a charging current limited to 3 Amps.

3. The power tool battery pack charger of claim 1, wherein the first charge mode includes a charging current limited to 6 Amps.

4. The power tool battery pack charger of claim 1, wherein the first microcontroller unit is configured to bidirectionally communicate with the second microcontroller unit via the opto-isolation circuit.

5. The power tool battery pack charger of claim 1, wherein the first microcontroller unit is configured to control a first power supply of the power tool battery charger and the second microcontroller is configured to control a second power supply of the power tool battery charger, wherein the first power supply and the second power supply are electrically isolated within the power tool battery charger.

6. The power tool battery pack charger of claim 1, wherein the indicator indicates a fast charge mode.

7. The power tool battery pack charger of claim 1, wherein the indicator indicates at least a subset of the plurality of battery pack interfaces are charging a connected battery pack using a fast charge mode.

8. The power tool battery pack charger of claim 1, further comprising an input mechanism configured to generate the signal.

9. The power tool battery pack charger of claim 1, wherein the indicator is positioned on a surface of a housing of the battery charger.

10. The power tool battery pack charger of claim 1, wherein the second microcontroller unit is configured to control the indicator to indicate interruption of communication with the first microcontroller unit.

11. The power tool battery pack charger of claim 1, wherein the opto-isolation circuit includes an optocoupler.

12. A method of operating a battery charger configured to charge a plurality of battery packs, the method including:
controlling, via a first microcontroller unit included in the battery charger, a charge operation of at least a first one of the plurality of battery packs based on a selected charge mode;
communicating, via an opto-isolation circuit included in the battery charger, the selected charge mode to a second microcontroller unit included in the battery charge; and
controlling, via the second microcontroller unit, a charge operation of at least a second one of the plurality of battery packs based on the selected charge mode.

13. The method of claim 12, further comprising receiving the selected charge mode via an input mechanism of the battery charger.

14. The method of claim 12, further comprising determining the selected charge mode based on at least one selected from a group consisting of a parameter of at least one of the plurality of battery packs, a parameter of the battery charger, and a parameter of an operating environment of the battery charger.

15. The method of claim 12, further comprising communicating, via the opto-isolation circuit, a communication confirmation from the second microcontroller unit.

16. The method of claim 12, further comprising controlling, via at least one of the first microcontroller unit and the second microcontroller unit, an indicator to indicate the selected charge mode.

17. A system for controlling a charge mode of a battery charger, the system comprising:
a first microcontroller unit configured to charge a first battery pack via a first power source;
a second microcontroller unit configured to charge a second battery pack via a second power source, the second power source electrically isolated from the first power source;
an opto-isolation circuit; and
an input mechanism,
the first microcontroller unit configured to:
receive a signal output by the input mechanism, the signal representing a selected charge mode;
control charging of the first battery pack via the first power source based on the selected charge mode; and
communicate the selected charge mode to the second microcontroller unit via the opto-isolation circuit.

18. The system of claim 17, wherein the second microcontroller unit is configured to communicate a communication confirmation to the first microcontroller unit via the opto-isolation circuit.

19. The system of claim 17, further comprising an indicator, wherein at least one of the first microcontroller unit and the second microcontroller unit is configured to control the indicator to indicate the selected charge mode.

20. The system of claim 19, wherein the indicator indicates when the selected charge mode is a fast charge mode.
